(19) United States
(12) Patent Application Publication
(10) Pub. No.: US 2026/0241741 A1
(43) Pub. Date: Aug. 20, 2026

(54) VARIABLE AERO WHEEL COVER

(71) Applicant: Vasile Vintila, Loxahatchee, FL (US)

(72) Inventor: Vasile Vintila, Loxahatchee, FL (US)

(21) Appl. No.: 19/055,855

(22) Filed: Feb. 18, 2025

(51) Int. Cl. B60B 7/20

(52) U.S. Cl. CPC B60B 7/20; B60B 2900/1216

(57) ABSTRACT

This concept reduces the wheel aerodynamic drag to the minimum level technologically possible by introducing a new aero wheel cover with variable configuration in order to completely cover the outboard side of the wheel by extending to create a contiguous surface when pre-determined requirements are fulfilled and retracting back to the initial position when the pre-determined requirements are no longer met.

### SPECIFICATION

This concept is designed to partially or completely cover the wheel's outboard surface, depending on the vehicle speed and user's preference.

The purpose is to reduce the wheel aerodynamic drag to the lowest level technologically possible by creating a contiguous outer wheel surface.

### DRAWINGS

FIG. 1 (Assembly) is a representation of all the components assembled.

FIG. 2 (Fixed cover) is a representation of the outer wheel cover.

FIG. 3 (Rotating cover) is a representation of the inner wheel cover.

FIG. 4 (Centrifugal hub) is a representation of the centrifugal hub and components

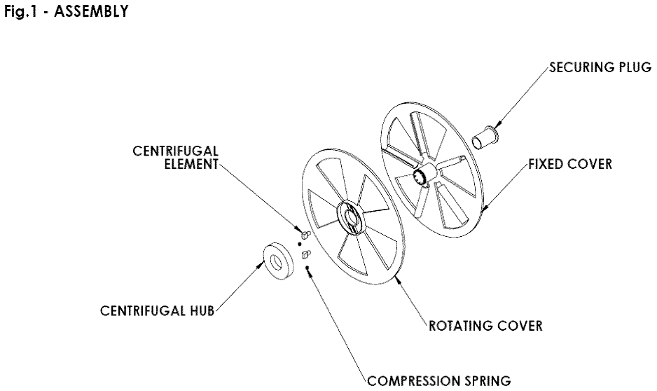

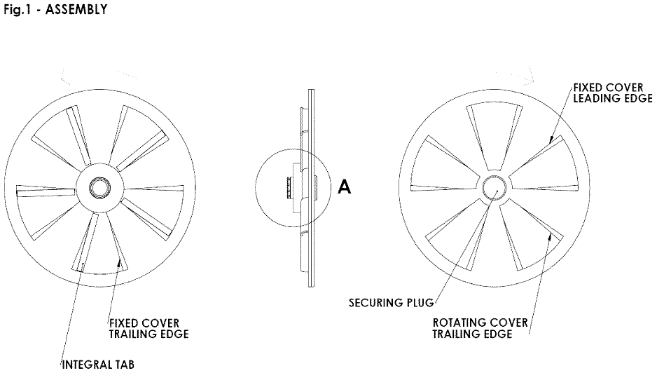

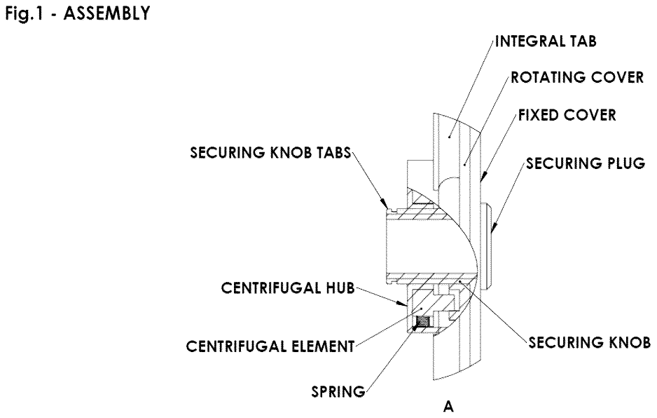

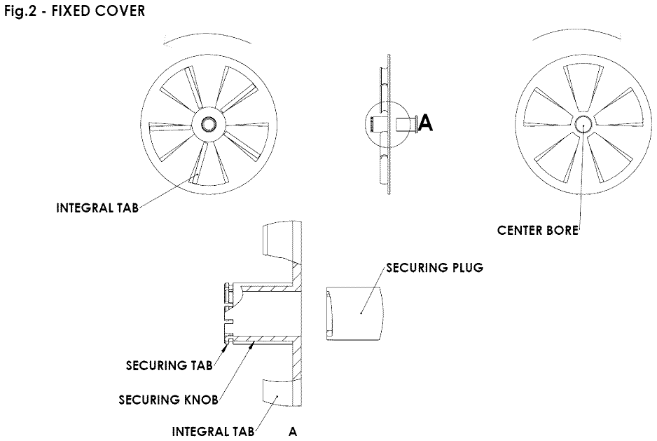

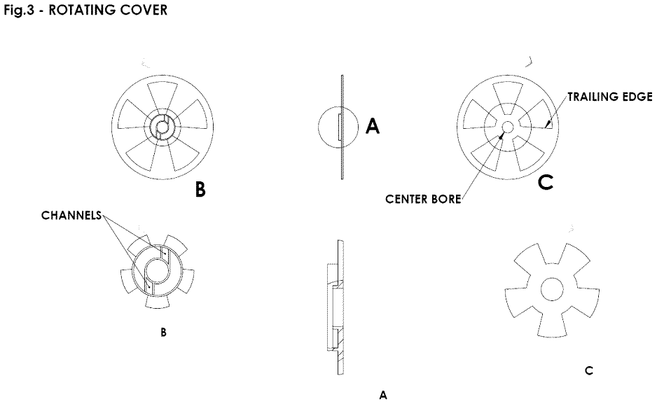

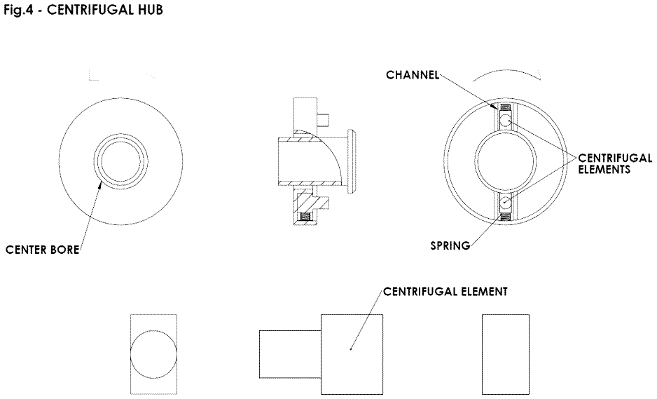

### DESCRIPTION

The outer cover is fixed in relation to the wheel. It is attached directly to the wheel spokes by means of integral tabs and it is secured to the wheel's center bore by an integral securing knob and an additional securing plug.

The securing knob is part of the fixed cover, and it is cylindrical and hollow. Its shoulder rests on the outer surface of the wheel center bore. The securing knob shoulder ends with securing tabs which engage tightly with the inner surface of the wheel center bore.

The securing plug fits tightly through the securing knob and reaches the end of the securing tabs. It can be fitted with a notch to lock the rotating cover in the extended position if needed.

The rotating cover is designed so that its outer surface matches closely the inner surface of the fixed cover. It has a center bore which matches the external diameter of the securing knob and allows it to freely rotate in relation to the fixed cover.

The inboard side of the rotating cover has two or more inclined channels along which the protruding part of the centrifugal elements (of the centrifugal hub) can slide, depending on the wheel speed. These channels match those present on the centrifugal hub.

The centrifugal hub is installed after the rotating cover on the securing knob and rests against the outer wheel surface when the whole cover assembly is installed on the wheel. The outboard side of the centrifugal hub has two or more radial channels along which the corresponding centrifugal elements can slide based on the wheel speed. The centrifugal elements are spring loaded so that they normally rest at the hub's center bore.

The centrifugal hub is directly attached to the securing knob, in solidarity with the fixed cover. It will be designed to match the inboard side of the rotating cover in order to protect the centrifugal elements, springs and channels against water ingress and dust and debris contamination.

Assembly and installation steps:
the rotating cover is installed inside the fixed cover, over the securing knob and with their matching surfaces facing each other,
the centrifugal hub is mounted on the securing knob with the radial channels facing the rotating cover, so that each protruding part of the centrifugal element engages its corresponding channel of the rotating cover,
the whole assembly is then installed on the wheel by engaging the tabs of the securing knob with the wheel center bore and turning the assembly in the opposite direction of the wheel rotation until the integral tabs of the fixed cover fully engage with the wheel spokes,
the securing plug is then pushed all the way through the securing knob so that the securing tabs are locked in their engagement with the wheel center bore.

### OPERATION

When the vehicle is stationary or at low speeds, the centrifugal elements are pushed by their corresponding springs to the bottom of the radial channels, next to the securing knob. Due to the orientation of the inclined channels of the rotating cover, the centrifugal elements will push this cover to the retracted position behind the fixed cover.

As the vehicle starts moving, the centrifugal force acting upon the centrifugal elements causes them to slide outwards along the radial channels. Due to their engagement with the inclined channels, the centrifugal elements will cause the rotating cover to turn around the securing knob and begin blocking the openings between the wheel spokes.

At a certain vehicle speed, the centrifugal elements will cause the rotating cover to extend all the way, completely blocking the openings between the wheel spokes. In this position, the trailing edges of the rotating cover are in direct contact with the leading edges of the fixed cover, thus creating a contiguous wheel surface. These edges will be designed so that they interlock when the rotating cover is fully extended, to provide reinforcement and eliminate vibrations.

As the vehicle slows down, the centrifugal force acting upon the centrifugal elements decreases, allowing them to slide towards the securing knob and causing the rotating cover to disengage from the fixed cover and gradually retract behind it.

The advantages of this concept are
reducing the vehicle's fuel/energy consumption by reducing the wheel aerodynamic drag to the minimum technologically possible,
allowing a wider range of aesthetic wheel designs,
reducing the amount of metal used and the cost of wheel manufacturing by designing basic wheels matched with aesthetically appealing wheel covers,
allowing more economical options for wheel cover materials and manufacturing,
making it possible to use multiple wheel cover designs with the same set of basic wheels,
allowing more air flow to cool down the brakes in city traffic,
reducing the air pollution with brake dust when the wheel cover is fully extended.

1. The variable aero wheel cover can change its configuration based on vehicle speed or user requirements, in order to completely cover the wheel's outboard surface and reduce the aerodynamic drag of the wheel to the minimum level technologically possible.

2. The variable aero wheel cover uses the internally created centrifuge force as the main driver for configuration change. Alternative drivers for configuration change can also be used (e.g. electric actuators, pressure/vacuum actuators, inertial actuators etc.).

3. A designated basic wheel set can be built to be used with multiple variable aero wheel cover designs.
